(19) United States
(12) Patent Application Publication
(10) Pub. No.: US 2011/0229367 A1
(43) Pub. Date: Sep. 22, 2011

(54) COPPER NICKEL ALUMINUM ALLOY

(76) Inventor: SHAU-KUAN CHIU, Huizhou City (CN)

(21) Appl. No.: 13/049,116

(22) Filed: Mar. 16, 2011

Related U.S. Application Data
(60) Provisional application No. 61/340,517, filed on Mar. 17, 2010.

(51) Int. Cl. C22C 9/01; C22C 9/06; C22C 9/02; A44C 15/00; A44C 9/00; A44B 9/16; A44B 6/00; A44B 1/04; A44B 11/00; F16B 2/02; G04B 37/00

(52) U.S. Cl. 420/471; 420/486; 63/3; 63/15; 24/706; 24/66.11; 24/102 R; 63/12; 24/163 K; 24/455; 368/280

(57) ABSTRACT

An alloy including at least 6 weight percent aluminum, greater than 6 weight percent nickel, and at least 50 weight percent copper. In some embodiments, the alloy includes 6 to 9 weight percent aluminum, 6 to 11 weight percent nickel, 1.5 to 3 weight percent iron, 1.5 to 3 weight percent manganese, 1 to 3 weight percent silicon, 1 to 5 weight percent tin, and 75 to 80 weight percent copper. The alloy is particularly suitable for jewelry, e.g., wrist watches, and materials exposed to aquatic environments for extended periods of time, e.g., boat hulls and boat propellers.

### CROSS-REFERENCE TO RELATED APPLICATIONS

This application claims priority under 35 USC §119(e)(1) to U.S. Provisional Application Ser. No. 61/340,517, filed on Mar. 17, 2010, the entire contents of which are incorporated herein by reference.

### BACKGROUND

Bronze is a metal alloy having copper as the primarily component, usually with tin as the main additive, but sometimes with other elements such as phosphorus, manganese, aluminum, or silicon. Bronze is typically 88% copper and 12% tin. Alpha bronze consists of the alpha solid solution of tin in copper. Alpha bronze alloys of 4-5 weight percent tin are used to make coins, springs, turbines and blades. Commercial bronze (90 weight percent copper and 10 weight percent zinc) and Architectural bronze (57 weight percent copper, 3 weight percent lead, 40 weight percent zinc) are actually brass alloys because they contain zinc as the main alloying ingredient. They are commonly used in architectural applications.

The discovery of bronze enabled people to create better metal objects than was previously possible. Tools, weapons, armor, and various building materials, such as decorative tiles made of bronze were harder and more durable than their stone and copper (“Chalcolithic”) predecessors. Initially bronze was made out of copper and arsenic to form arsenic bronze. It was only later that tin was used, becoming the sole type of bronze in the late 3rd millennium BC. Tin bronze was superior over arsenic bronze in that the alloying process itself could more easily be controlled (as tin was available as a metal) and the alloy was stronger and easier to cast. Also, unlike arsenic, tin is not toxic. The earliest tin-alloy bronzes date to the late 4th millennium BC in Susa (Iran) and some ancient sites in Luristan (Iran) and Mesopotamia (Iraq).

Typically bronze readily oxidizes to form cupric oxide and/or cuprous oxide. Normal atmospheric exposure also results in the formation of copper carbonate. Moreover, exposure to various corrosive environments can result in copper sulfides and other copper salts on the surface of typical bronze alloys. Cupric oxide produces a blackened blemish, whereas cuprous oxide produces a reddish blemish. Copper carbonate is a blue-green compound, and various other copper salts also have bluish/greenish colors. The formation of copper oxides, copper carbonate, copper sulfides, and/or other copper salts tarnish the bronze, but can allow the bronze to resist further corrosion. The tarnishing of bronze, especially the formation of bluish/greenish corrosion products, makes bronze a less than desirable material for jewelry. Human perspiration (e.g., sweat) is a highly corrosive mixture of water, various dissolved solids (chiefly chlorides), the odorants 2-methylphenol (o-cresol) and 4-methylphenol (p-cresol), and urea, which can result in the rapid tarnishing of typical bronze compositions when in close contact with human skin. Bronze jewelry is known to often leave a green/blue stain on a wearer.

To prevent such tarnishing, a variety of clear coatings have been developed that are either very costly or are subject to damage during use, which can result in local tarnishing and corrosion under the coating. Thus, while the majority of copper base alloys possess the required formability for fashioning into useful articles, their lack of tarnish resistance limits their use in areas where these articles are also intended to serve a decorative function. The search for a copper base alloy having a stainless property, that is, one that does not require a protective coating, has been active for many years.

### SUMMARY

An alloy is described that includes at least 6 weight percent aluminum, greater than 6 weight percent nickel, and at least 50 weight percent copper. In particular embodiments, the alloy is used in jewelry.

The alloy is a copper based alloy. In some embodiments, the alloy includes at least 70 weight percent copper. For example, the alloy can include between 75 and 80 weight percent copper. In some embodiments, the alloy includes between 76 and 78 weight percent copper.

The alloy can include between 6 and 9 weight percent aluminum. In some embodiments, the alloy includes between 8 and 8.5 weight percent aluminum.

The alloy can include less than or equal to 11 weight percent nickel. In some embodiments, the alloy includes between 7 and 10 weight percent nickel. For example, the alloy can include between 8 and 9 weight percent nickel.

The alloy can include iron and/or manganese. In some embodiments, the alloy includes at least 3 weight percent iron plus manganese. In some embodiments, the alloy includes less than 6 weight percent iron plus manganese. For example, the alloy can include between 3 and 6 weight percent of iron plus manganese. In some embodiments, the alloy includes between 1.5 and 3 weight percent iron. In some embodiments, the alloy includes between 1.5 and 3 weight percent manganese. For example, the alloy can include about 2 weight percent iron and about 2 weight percent manganese.

The alloy can include silicon. In some embodiments, the alloy can include at least 1 weight percent silicon. In some embodiments, the alloy includes less than or equal to 3 weight percent silicon. For example, the alloy can include between 1 and 3 weight percent silicon.

The alloy can include tin. In some embodiments, the alloy can include at least 1 weight percent tin. In some embodiments, the alloy includes less than or equal to 5 weight percent tin. For example, the alloy can include between 1 and 5 weight percent tin. In some embodiments, the alloy includes between 1 and 2 weight percent of tin. For example, the alloy can include about 2 weight percent tin. In some embodiments, the tin can be replaced with lead or used alongside lead. For example, in some embodiments, the alloy includes 1 weight percent tin and 1 weight percent lead.

The alloy can include less than 500 ppm oxygen. In some embodiments, the alloy includes less than 200 ppm oxygen.

The alloy can further include additional elements. In some embodiments, the alloy has a maximum of 5 weight percent of elements other than copper, aluminum, iron, manganese, nickel, silicon, and tin. In some embodiments, the alloy has a maximum of 3 weight percent of elements other than copper, aluminum, iron, manganese, nickel, silicon, and tin. For example, the alloy can be limited to have a maximum of 0.5 weight percent of elements other than copper, aluminum, iron, manganese, nickel, silicon, and tin. Each element other than copper, aluminum, iron, manganese, nickel, silicon, and tin can be limited to a maximum of 1 weight percent. In some embodiments, each element other than copper, aluminum, iron, manganese, nickel, silicon, and tin can be limited to a maximum of 0.1 weight percent.

The alloy can be used in jewelry. The jewelry can be a time piece, a necklace, a ring, a brooch, a tie clip, a cuff link, a nose ring, a tongue ring, a navel ring, a bracelet, a connecting link, a bangle, a belt buckle, a clasp, a jump ring, a spring ring, or a lobster claw closure. For example, the jewelry can be a wrist watch. The alloy can be used to make one or more of the following components of a wrist watch: a case body, a case back, a bezel, a turning top ring, a bracelet end piece, a connecting link, a crown, an external pusher, an internal pusher, a decorative case ornament, a decorative case cover, a hinge, a tube, a pin or any component used on a watch case or bracelet. In other embodiments, the alloy is used as a part of a boat, e.g., a boat hull or propeller.

One advantage of the alloy is that the alloy shows resistance to tarnishing. Another advantage of the alloy is that the alloy also shows a resistance to the attachment of sea life, such as barnacles, when placed within an aquatic environment.

The details of one or more embodiments are set forth in the accompanying drawings and the description below. Other features, objects, and advantages will be apparent from the description and drawings, and from the claims.

### DESCRIPTION OF DRAWINGS

FIG. 1 is a wrist watch.

FIG. 2 is an earring.

FIG. 3 is a boat.

FIG. 4 is a propeller.

FIGS. 5A and 5B show the results from an artificial sweat test of an alloy according to one embodiment.

FIG. 6 shows the results from an artificial sweat test of a commercially available bronze alloy.

FIGS. 7A and 7B show the results from an artificial sweat test of a 50 cent European coin.

Like reference symbols in the various drawings indicate like elements.

### DETAILED DESCRIPTION

The alloy is a copper based alloy having at least 6 weight percent aluminum and greater than 6 weight percent nickel. Copper based alloys include at least 50 weight percent copper. The alloy can also include iron, manganese, silicon, and/or tin. In some embodiments, the alloy includes 75 to 80 weight percent copper, 6 to 9 weight percent aluminum, 1.5 to 3 weight percent iron, 1.5 to 3 weight percent manganese, between 6 and 11 weight percent nickel, 1 to 3 weight percent silicon, and 1 to 5 weight percent tin. The alloy can also have an oxygen concentration of less than 500 parts per million (ppm). The alloy can also include impurity levels of other constituents. In some embodiments, the alloy includes less than 5 weight percent, in sum, of elements other than copper, aluminum, nickel, iron, manganese, silicon, and tin. As used herein, the term “consisting essentially of” restricts an alloy to include less than 3 weight percent, in sum, of elements not listed. In some embodiments, the alloy consists of 75 to 80 weight percent copper, 6 to 9 weight percent aluminum, 1.5 to 3 weight percent iron, 1.5 to 3 weight percent manganese, between 6 and 11 weight percent nickel, 1 to 3 weight percent silicon, 1 to 5 weight percent tin, and no more than 0.5 weight percent of impurities.

The alloy has been found to possess superior resistance to tarnishing as compared to other bronze alloys, especially when exposed to highly corrosive environments, such as human sweat or aquatic environments. The alloy also has an attractive appearance. Accordingly, this alloy is useful for making jewelry. The alloy also has been found to resist attachment of sea life, such as barnacles, when placed within an aquatic environment. The alloy is thus also useful for making boat parts, such as boat hulls and boat propellers, or other parts designed for long term submersion in an aquatic environment.

### Alloy Constituents

The base constituent of the alloy is copper (Cu), thus the alloy includes at least 50 weight percent copper. In some embodiments, the alloy includes at least 70 weight percent copper. For example, alloy can have between 75 and 80 weight percent copper. A freshly exposed surface of pure copper has a pinkish or peachy color, but oxides of copper can have a reddish, orangish, or brownish color. Copper, caesium and gold are the only three elemental metals with a natural color other than gray or silver, but caesium is liquid at room temperature and gold is considerably more expensive. The copper content of the alloy thus produces a pleasant appearance.

The alloy includes at least 6 weight percent aluminum (Al). In some embodiments, the alloy includes 6-9 weight percent aluminum. For example, the aluminum content of at least one specific formula of the alloy is between 8 and 8.5 weight percent. The inclusion of aluminum reduces the density of the alloy. The inclusion of aluminum also alters the color of the alloy. With an increasing aluminum content, the alloy becomes more yellow. Alloys of the presently described compositions can have a pleasant pale straw color.

The alloy includes greater than 6 weight percent nickel (Ni). In some embodiments, the alloy includes at least 8 weight percent nickel. The alloy can also include greater than 6 weight percent and less than 11 weight percent nickel. In some embodiments, the alloy includes between 7 and 10 weight percent nickel. For example, the nickel content within some specific formulas of the alloy is between 8 and 8.5 weight percent. The inclusion of nickel increases the tarnish resistance and hardness. The total amount of nickel within the alloy can, however, be limited by concerns over the toxicity of nickel. For alloys in contact with human skin, it is important that significant amounts of nickel do not leach out of the alloy. Alloys containing nickel are regulated by the European Union according to the Nickel Directive—Directive 94/27/EC, amended by Directive 2004/96/EC, which limits the amount of nickel content in products intended to come into prolonged contact with the skin. The maximum nickel release rate is <0.5 μg/cm²/week. To ensure compliance with this directive, items which come into prolonged contact with the skin are to be tested according to the European nickel release standard EN1811:1999.

The alloy can include silicon (Si). In some embodiments, the alloy includes at least 1 weight percent silicon. In some embodiments, the alloy includes less than 3 weight percent silicon. For example, in at least one specific formulation, the alloy includes between 1.5 and 2.5 weight percent silicon. The silicon increases the tarnish resistance of the alloy. Silicon improves the flexibility and hardness of the alloy. Silicon makes the alloy appear darker, but also gives the alloy shinier polished surfaces.

The alloy can also include iron (Fe) and/or manganese (Mn). The presence of iron and/or manganese in the alloy can result in a finer grain size. In some embodiments, the alloy can have phases having average diameter of about 10 microns. In some embodiments, the alloy includes at least 3 weight percent of iron plus manganese. Excessive iron, however, can make the alloy inflexible. Excessive manganese, on the other hand, can make the alloy too hard. In some embodiments, the alloy includes less than or equal to 6 weight percent of iron plus manganese. For example, the alloy can include 1.5-3 weight percent of each of iron and manganese. Some specific formulations of the alloy include 2-2.5 weight percent of each of iron and manganese.

The alloy can include tin (Sn). In some embodiments, the alloy includes at least 1 weight percent tin. In some embodiments, the alloy includes less than 5 weight percent tin. For example, some specific formulations of the alloy include between 1.0 and 2.0 weight percent tin. Tin is a malleable, low melting point metal that improves the machinability of the alloy. The tin also improves the polish on the alloy. In some embodiments, lead (Pb) can be used along with or in place of tin.

The alloy can include various amounts of other elements of the periodic table. In some embodiments, the alloy includes less than 5 weight percent, in sum, of elements other than copper, aluminum, nickel, silicon, iron, manganese, and tin. The alloy can consist essentially of copper, aluminum, nickel, silicon, iron, manganese, and tin, meaning that other elements are limited to less than a total of 3 weight percent. In some embodiments, elements other than copper, aluminum, nickel, silicon, iron, manganese, and tin (“impurities”) can each be limited to less than 0.1 weight percent. Lead, phosphorous, and zinc may be common impurities with the sources of the constituent elements. In some embodiments, lead is maintained at levels below 600 ppm. Lead can also be maintained at below 200 ppm. In some embodiments, the alloy includes less than 0.5 weight percent, in sum, of impurities.

The oxygen (O) content of the alloy can be limited to less than 500 ppm. In some embodiments, the oxygen content of the alloy is less than 200 ppm. The oxygen content of the alloy can impact the alloy's tarnish resistance. In order to ensure that the oxygen content is minimized, a gas inlet stream can fill the furnace with an inert gas (e.g., Argon, Nitrogen) or a gas that reacts with oxygen (e.g., carbon monoxide). In some embodiments, a deoxidizer can be added to the furnace. For example, copper (I) phosphide, sodium chloride, or zinc chloride can be added to the furnace to preferentially react with oxygen. A gas outlet can allow oxygen and oxides to flow out of the furnace.

### Formulations and Testing

TABLE I

| | | Chemical Composition | | | | | | | | | | |
|---|---|---|---|---|---|---|---|---|---|---|---|---|
| Item | | Cu % | Al % | Fe % | Mn % | Ni % | P % | Pb % | Si % | Sn % | Zn % | other % |
| Standard | min % | 75.00 | 6.00 | 1.50 | 1.50 | 6.00 | — | — | 1.00 | 1.00 | — | — |
| Formula | max % | 80.00 | 9.00 | 3.00 | 3.00 | 11.00 | — | — | 3.00 | 5.00 | — | 0.50 |
| Formula #3 | min % | 76.00 | 9.00 | 2.00 | 2.50 | 8.00 | — | — | 2.00 | 1.50 | — | — |
| | max % | 78.00 | 9.50 | 2.50 | 3.00 | 8.50 | — | — | 2.50 | 2.00 | — | — |
| Formula #4 | min % | 75.00 | 8.00 | 2.00 | 2.00 | 8.00 | — | — | 1.50 | 1.00 | — | — |
| | max % | 80.00 | 8.50 | 2.50 | 2.50 | 8.50 | — | — | 2.50 | 1.50 | — | — |

TABLE II

| | | | Chemical Composition | | | | | | | | | | |
|---|---|---|---|---|---|---|---|---|---|---|---|---|---|
| | | | | | | | | | | | | | other |
| Item | Grade Code | | Cu % | Al % | Fe % | Mn % | Ni % | P % | Pb % | Si % | Sn % | Zn % | Max % |
| Al- | Commercial | HSCuAl | Bal | 7-9 | — | 2 | — | — | — | 0.1 | — | 0.1 | 0.5 |
| Bronze | Standard | | | | | | | | | | | | |
| | American | ERCuAl-Al | Bal | 6-8.5 | — | 0.5 | — | — | 0.02 | 0.1 | — | 0.2 | 0.5 |
| | Welding | | | | | | | | | | | | |
| | Society | | | | | | | | | | | | |
| | Standard | | | | | | | | | | | | |
| Si- | Commercial | HsCuSi | Bal | 0.01 | 0.5 | 1.5 | — | — | — | 2.8-4 | 1.1 | 1.5 | 0.5 |
| Bronze | Standard | | | | | | | | | | | | |
| | European | SG-CuSi3 | Bal | 0.01 | 0.3 | 0.5-1.5 | — | 0.02 | 0.02 | 2.8-4 | 0.2 | 0.2 | 0.4 |
| | standard | | | | | | | | | | | | |
| | American | ERCuSi-A | Bal | 0.01 | 0.5 | 1.5 | — | — | 0.02 | 2.8-4 | 1 | 1 | 0.5 |
| | Welding | | | | | | | | | | | | |
| | Society | | | | | | | | | | | | |
| | Standard | | | | | | | | | | | | |

TABLE III

| Modena Metalli Srl (Italy) | | | Chemical Composition | | | | | | | | | |
|---|---|---|---|---|---|---|---|---|---|---|---|---|
| UNI 5275 | | | Cu % | Al % | Fe % | Mn % | Ni % | P % | Pb % | Si % | Sn % | Zn % |
| Al- | CuAl11Fe4Ni4 | min % | 78.00 | 10.00 | 3.00 | 0.00 | 3.00 | | 0.05 | 0.05 | 0.10 | 0.10 |
| Bronze | | max % | 84.00 | 11.50 | 5.00 | 3.50 | 5.50 | — | 0.10 | 0.10 | 0.15 | 0.15 |
| | CuAl10Fe5Ni5 | min % | 76.00 | 8.50 | 4.00 | 0.00 | 4.00 | | 0.00 | 0.00 | 0.00 | 0.00 |
| | | max % | 83.00 | 10.50 | 5.50 | 3.00 | 6.00 | — | 0.03 | 0.10 | 0.10 | 0.50 |

Table I shows the composition of certain formulations of the alloy described herein. Tables II and III show the compositions of certain commercially available alloys for comparison.

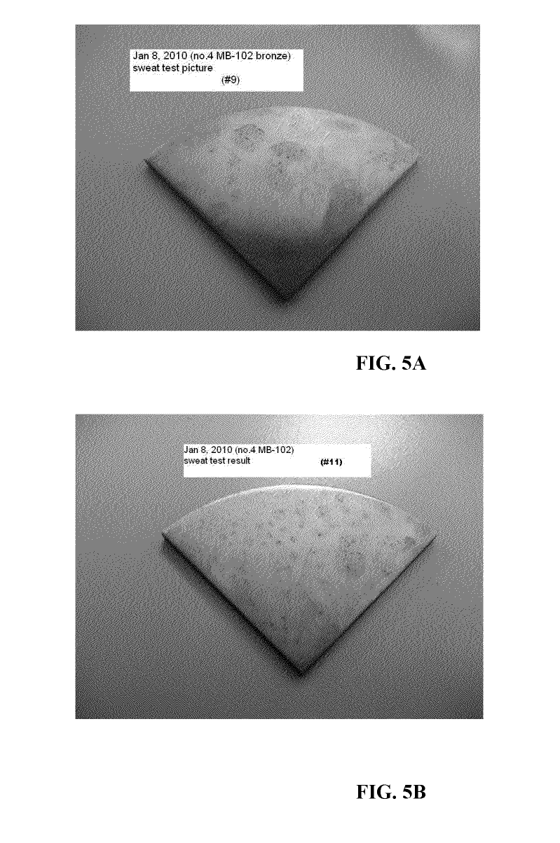

Formula 4 was subjected to an artificial sweat test, the results of which are shown in FIGS. 5A and 5B. The procedure used for the artificial sweat test is described below. As shown in FIGS. 5A and 5B, both test samples of Formula 4 had minimal tarnishing or color change.

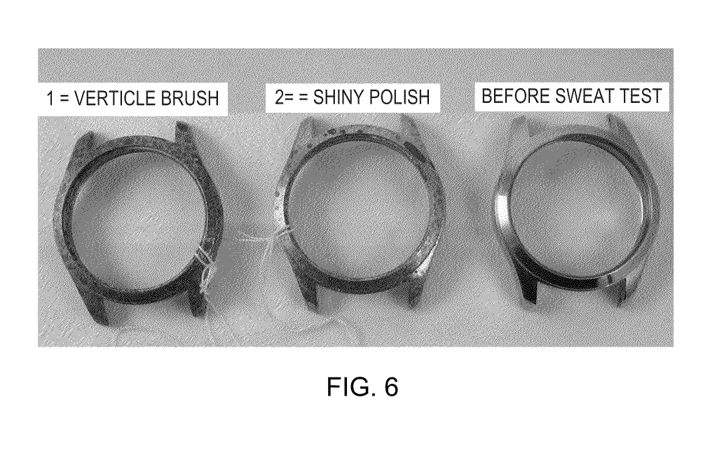

As a comparison, a commercially available bronze and a 50 cent European coin were also tested. It is our understanding that the commercially available bronze sample has a composition of 9 weight percent aluminum, 4 weight percent iron, and a balance of copper. The results of the artificial sweat test for the commercially available bronze are shown in FIG. 6, which is a photo of three rings. The first ring was subjected to the artificial sweat test and had a vertical brush finish prior to the test. The second ring was subject to the artificial sweat test and had a polished finish prior to the test. The third ring is an example of the commercially available bronze prior to the artificial sweat test. As shown in FIG. 6, the commercially available bronze had significantly more tarnishing than Formula 4.

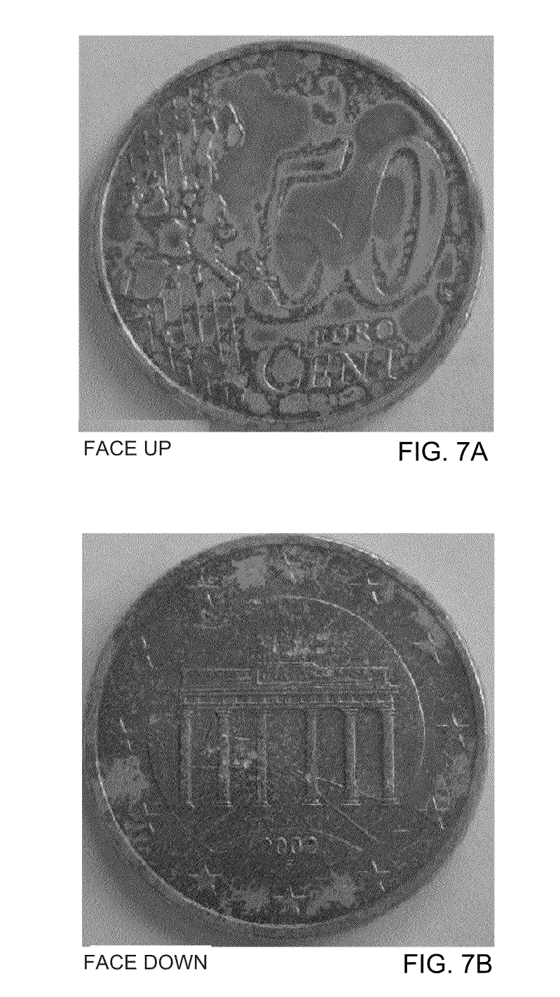

The 50 cent European coin has a composition of 5 weight percent aluminum, 5 weight percent zinc, 1 weight percent tin, and a balance of copper. The results of the artificial sweat test of the 50 cent European coin are shown in FIGS. 7A and 7B. The artificial sweat test of the European coin resulted in significantly more tarnishing and color change than the artificial sweat test of the Formula 4 alloy.

The artificial sweat test uses an aqueous test solution of 20.0 grams per liter of sodium chloride, 17.5 grams per liter of ammonia chloride, 5.0 grams per liter of urea, 2.5 grams per liter of acetic acid, 15.0 grams per liter of lactic acid, and a sufficient volume of sodium hydroxide to adjust the solution to a pH of 4.7. To perform the sweat test, the sample is placed in a closed vessel (e.g., a Pyrex® glass vessel) on a tray having through holes. The bottom of the closed vessel includes cotton soaked with the test solution. The soaked cotton fills at least the bottom 10 mm of the closed vessel. The tray is placed a minimum of 30 mm above the soaked cotton. The test begins by placing the sample on the tray and spraying a thin mist of the test solution over the surface of the sample. The tray is placed in the vessel, the vessel is closed, and the vessel is maintained at a temperature 40+/−2° C. for 24 hours. After the test, the sample is washed with distilled water and the surface of the sample is cleaned with a polishing cloth to ensure all of the test solution is removed. The sample is then evaluated by whether there is any color change, whether there are tarnishing droplets or corrosion, and whether there is any bubbling or pealing.

Moreover, alloy samples according to Formula 3 and Formula 4 were made and placed in the water of Hong Kong Harbor. After two months in the water of Hong Kong Harbor, each sample was darkened due to apparent production of copper oxides. The amount of oxidation, however, was less than expected. Moreover, each sample remained free of any barnacles or other sea life attached to the sample. Given the presence of barnacles and other sea life attached to other metal structures submerged in the Hong Kong Harbor, this finding was unexpected.

### Method of Making the Alloy

Alloys of the presently described compositions can be prepared by melting together the constituent metals within a furnace. Because some of the alloy components have significantly different melting temperatures, various elements can be separately melted outside of the furnace and added to the furnace in a melted state. In some embodiments, different temperature zones can be used for melting elements having significantly different melting temperatures, with elements having similar melting temperatures being melted together. For example, a first zone can be used to melt Fe, Mn, Ni, and Si, a second zone can be used to melt Cu, and a third zone can be used to melt Al and Sn. Because Fe, Mn, Ni, and Si have melting temperatures of 1539° C., 1245° C., 1455° C., and 1403° C., respectively, the first zone can use a temperature of about 1600° C. to melt and mix Fe, Mn, Ni, and Si. Because Cu has a melting temperature of 1083° C., the second zone can use a temperature of about 1400° C. to melt the Copper.

The third zone can melt the elements of Al and Sn at a lower temperature because Al has a melting temperature of 660° C. and Sn has a melting temperature of 231.9° C. The metals of each zone can then be mixed at a temperature of about 1400° C. in the furnace to produce a solution of the elements. In other embodiments, all of the elements can be melted together at a temperature of, for example, 1600° C. Melting all of the elements together, however, can result in the vaporization of some of the elements having a lower melting temperature (e.g., Al or Sn), thus the amount of each element added to the furnace may need to be adjusted to account for elements lost to vaporization.

The need to mix the metals in the furnace, however, can limit the ability to maintain a low oxygen environment within the furnace. Accordingly, in order to ensure that the oxygen content is minimized, a gas inlet stream can fill the furnace with an inert gas (e.g., argon, nitrogen) or a gas that reacts with oxygen (e.g., carbon monoxide). In some embodiments, a deoxidizer can be added to the furnace. For example, copper (I) phosphide, sodium chloride, or zinc chloride can be added to the furnace to preferentially react with oxygen. A gas outlet can allow oxygen and oxides to flow out of the furnace. Moreover, tin (Sn) may oxidize if oxygen is present in the furnace. The oxidized tin can precipitate out of the solution of elements and be removed before solidification. Once the constituents are mixed into a solution, the alloy is poured into a mold and cooled. After the alloy is cooled, the alloy can be subjected to mechanical shaping and/or polishing.

### Uses

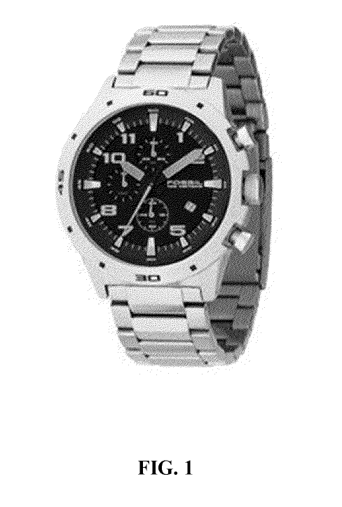

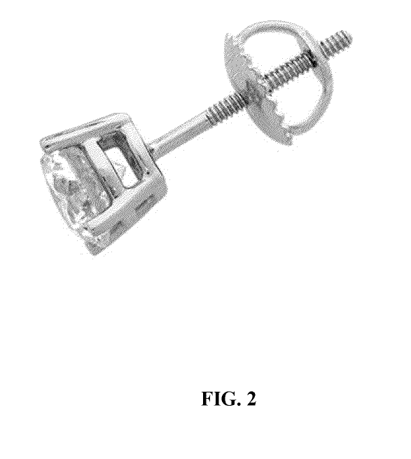

The alloy can be used in a host of fields. In particular, the alloy is suitable for use in items in contact with human skin. Because of the alloy's pleasing appearance and strong resistance to tarnishing, especially when exposed to human skin, the alloy is particularly suitable for use in jewelry. Moreover, the alloy may slowly build up a layer of copper oxide during the first few years of use without the development of any blue/green corrosion products. A thin layer of copper oxide, without the presence of any blue or green compound, can give the alloy a rustic appearance without causing the user to have blue or green stains on his/her body. In some embodiments, the jewelry is a time piece (e.g., a wrist watch), as shown in FIG. 1. The components include, a case body, a case back, a bezel, a turning top ring, a bracelet end piece, a connecting link, a crown, an external pusher, an internal pusher, a decorative case ornament, a decorative case cover, a hinge, a tube, a pin or any component used on a watch case or bracelet. FIG. 2 depicts an earring that can have an alloy according to the described compositions. In other embodiments, the jewelry can be a necklace, a ring, a brooch, a tie clip, a cuff link, a nose ring, a tongue ring, a navel ring, a bracelet, a connecting link, a bangle, a belt buckle, a clasp, a jump ring, a spring ring, a lobster claw closure, or any component used on a jewelry article.

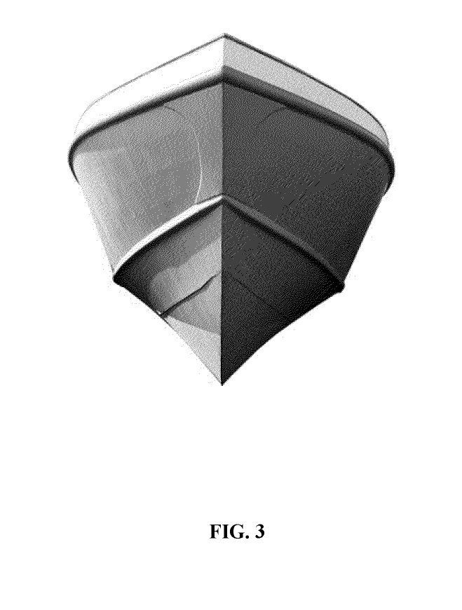

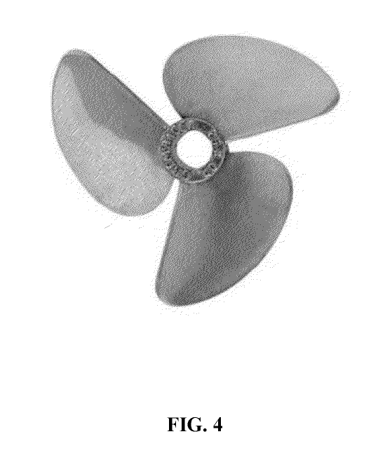

The alloy is also suitable for use in aquatic environments. In some embodiments, the alloy can be used in a boat hull, such as on a boat as shown in FIG. 3. In other embodiments, the alloy can be used as a propeller or turbine for a boat, such as shown in FIG. 4. Other possible uses include docks, drainage gratings, hinges, winches, latches, hooks, catches, chocks, cleats, eye bolt, eye strap, handles, pulls, rings, gudgeons, pintles, snap hooks, latches or as any other item placed in or near sea water.

A number of embodiments have been described. Nevertheless, it will be understood that various modifications may be made without departing from the spirit and scope of this disclosure. Accordingly, other embodiments are within the scope of the following claims.

What is claimed is:

1. An article of jewelry comprising an alloy, the alloy comprising at least 6 weight percent aluminum, greater than 6 weight percent nickel, and at least 50 weight percent copper.

2. The article of jewelry of claim 1 wherein the alloy comprises iron or manganese, wherein the alloy comprises between 3 and 6 weight percent of iron plus manganese.

3. The article of jewelry of claim 1 wherein the alloy comprises between 1.5 and 3 weight percent iron.

4. The article of jewelry of one of claim 1 wherein the alloy comprises between 1.5 and 3 weight percent manganese.

5. The article of jewelry of one of claim 1 wherein the alloy comprises between 1 and 3 weight percent silicon.

6. The article of jewelry of claim 1 wherein the alloy comprises between 1 and 5 weight percent tin.

7. The article of jewelry of claim 1 wherein the alloy comprises at least 70 weight percent copper.

8. The article of jewelry of claim 7 wherein the alloy comprises between 75 and 80 weight percent copper.

9. The article of jewelry of claim 1 wherein the alloy comprises less than or equal to 9 weight percent aluminum.

10. The article of jewelry of claim 1 wherein the alloy comprises less than or equal to 11 weight percent nickel.

11. The article of jewelry of claim 1 wherein the alloy comprises less than 500 ppm oxygen.

12. The article of jewelry of claim 1 wherein the jewelry is a time piece, a necklace, a ring, a brooch, a tie clip, a cuff link, a nose ring, a tongue ring, a navel ring, a bracelet, a connecting link, a bangle, a belt buckle, a clasp, a jump ring, a spring ring, or a lobster claw closure.

13. The article of jewelry of claim 1 wherein the jewelry comprises a member consisting of the alloy.

14. The article of jewelry of claim 1 wherein the alloy consists essentially of copper, aluminum, iron, manganese, nickel, silicon, and tin.

15. The article of jewelry of one of claim 1 wherein the alloy consists of
aluminum in an amount of between 6 weight percent and 9 weight percent,
nickel in an amount greater than 6 weight percent and less than or equal to 11 weight percent,
iron in an amount of between 1.5 weight percent and 3 weight percent,
manganese in an amount of between 1.5 weight percent and 3 weight percent,
silicon in an amount of between 1 weight percent and 3 weight percent,
tin in an amount of between 1 weight percent and 5 weight percent, and
a balance of copper, with the alloy comprising less than 0.5 weight percent, in sum, of any other element.

16. An alloy comprising at least 6 weight percent aluminum, greater than 1.5 weight percent manganese, greater than six weight percent nickel, and at least 50 weight percent copper.

17. The alloy of claim 16 wherein the alloy comprises between less than or equal to 9 weight percent aluminum, less than or equal to 3 weight percent manganese, and less than or equal to 11 weight percent nickel.

18. The alloy of claim 16 wherein the alloy consists of
aluminum in an amount of between 6 weight percent and 9 weight percent,
nickel in an amount greater than 6 weight percent and less than or equal to 11 weight percent,
iron in an amount of between 1.5 weight percent and 3 weight percent,
manganese in an amount greater than 1.5 weight percent and less than or equal to 3 weight percent,
silicon in an amount of between 1 weight percent and 3 weight percent,
tin in an amount of between 1 weight percent and 5 weight percent, and
a balance of copper, with the alloy comprising less than 0.5 weight percent, in sum, of any other element.

19. The alloy of claim 16 wherein the alloy is part of a boat hull or a boat propeller.

20. A boat comprising an alloy comprising:
at least 6 weight percent aluminum,
greater than 6 weight percent nickel,
at least 3 weight percent iron, manganese, or a combination thereof,
at least 1 weight percent silicon,
at least 1 weight percent tin, lead, or a combination thereof, and
a balance of copper, wherein the alloy comprises less than 5 weight percent, in sum, of any other element.
